(19) United States
(12) Patent Application Publication
(10) Pub. No.: US 2012/0163248 A1
(43) Pub. Date: Jun. 28, 2012

(54) Baton Handover From TDD-LTE to TD-SCDMA Systems

(76) Inventors: Tom Chin, San Diego, CA (US); Guangming Shi, San Diego, CA (US); Kuo-Chun Lee, San Diego, CA (US)

(21) Appl. No.: 12/977,482

(22) Filed: Dec. 23, 2010

(51) Int. Cl. H04W 36/00; H04W 52/04; H04L 12/26; H04W 24/00; H04J 3/00; H04W 92/00

(52) U.S. Cl. 370/280; 455/436; 370/331; 370/252

(57) ABSTRACT

Certain aspects of the present disclosure propose techniques for performing a baton handover from TDD-LTE to TD-SCDMA systems. Certain aspects provide a method that generally includes receiving a handover command to handover from a base station (BS) of a first radio access technology (RAT) to a BS of a second RAT, switching uplink (UL) transmission from the BS of the first RAT to the BS of the second RAT, maintaining downlink (DL) transmission with the BS of the first RAT after switching the UL transmission to the BS of the second RAT, and switching the DL transmission from the BS of the first RAT to the BS of the second RAT after switching the UL transmission to the BS of the second RAT.

### BACKGROUND

1. Field

Certain aspects of the present disclosure generally relate to wireless communications and, more particularly, to performing a baton handover from a base station (BS) of a first radio access technology (RAT) to a BS of a second RAT.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, in certain locations, TD-SCDMA is being pursued as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In an aspect of the disclosure, a method for wireless communications is provided. The method generally includes sending a handover command to a user equipment (UE), wherein the handover command instructs the UE to handover from a base station (BS) of a first radio access technology (RAT) to a BS of a second RAT; maintaining downlink (DL) transmission with the UE after sending the handover command, wherein the DL transmission is maintained until a condition is met; and discontinuing DL transmission to the UE after the condition is met.

In an aspect of the disclosure, an apparatus for wireless communications is provided. The apparatus generally includes means for sending a handover command to a user equipment (UE), wherein the handover command instructs the UE to handover from a base station (BS) of a first radio access technology (RAT) to a BS of a second RAT; means for maintaining downlink (DL) transmission with the UE after sending the handover command, wherein the DL transmission is maintained until a condition is met; and means for discontinuing DL transmission to the UE after the condition is met.

In an aspect of the disclosure, an apparatus for wireless communications is provided. The apparatus generally includes at least one processor and a memory coupled to the at least one processor. The at least one processor is typically adapted to send a handover command to a user equipment (UE), wherein the handover command instructs the UE to handover from a base station (BS) of a first radio access technology (RAT) to a BS of a second RAT; maintain downlink (DL) transmission with the UE after sending the handover command, wherein the DL transmission is maintained until a condition is met; and discontinue DL transmission to the UE after the condition is met.

In an aspect of the disclosure, a computer-program product is provided. The computer-program product generally includes a computer-readable medium having code for sending a handover command to a user equipment (UE), wherein the handover command instructs the UE to handover from a base station (BS) of a first radio access technology (RAT) to a BS of a second RAT; maintaining downlink (DL) transmission with the UE after sending the handover command, wherein the DL transmission is maintained until a condition is met; and discontinuing DL transmission to the UE after the condition is met.

In an aspect of the disclosure, a method for wireless communications is provided. The method generally includes receiving a handover command to handover from a base station (BS) of a first radio access technology (RAT) to a BS of a second RAT; switching uplink (UL) transmission from the BS of the first RAT to the BS of the second RAT; maintaining downlink (DL) transmission with the BS of the first RAT after switching the UL transmission to the BS of the second RAT; and switching the DL transmission from the BS of the first RAT to the BS of the second RAT after switching the UL transmission to the BS of the second RAT.

In an aspect of the disclosure, an apparatus for wireless communications is provided. The apparatus generally includes means for receiving a handover command to handover from a base station (BS) of a first radio access technology (RAT) to a BS of a second RAT; means for switching uplink (UL) transmission from the BS of the first RAT to the BS of the second RAT; means for maintaining downlink (DL) transmission with the BS of the first RAT after switching the UL transmission to the BS of the second RAT; and means for switching the DL transmission from the BS of the first RAT to the BS of the second RAT after switching the UL transmission to the BS of the second RAT.

In an aspect of the disclosure, an apparatus for wireless communications is provided. The apparatus generally includes at least one processor and a memory coupled to the at least one processor. The at least one processor is typically adapted to receive a handover command to handover from a base station (BS) of a first radio access technology (RAT) to a BS of a second RAT; switch uplink (UL) transmission from the BS of the first RAT to the BS of the second RAT; maintain downlink (DL) transmission with the BS of the first RAT after switching the UL transmission to the BS of the second RAT; and switch the DL transmission from the BS of the first RAT to the BS of the second RAT after switching the UL transmission to the BS of the second RAT.

In an aspect of the disclosure, a computer-program product is provided. The computer-program product generally includes a computer-readable medium having code for receiving a handover command to handover from a base station (BS) of a first radio access technology (RAT) to a BS of a second RAT; switching uplink (UL) transmission from the BS of the first RAT to the BS of the second RAT; maintaining downlink (DL) transmission with the BS of the first RAT after switching the UL transmission to the BS of the second RAT; and switching the DL transmission from the BS of the first RAT to the BS of the second RAT after switching the UL transmission to the BS of the second RAT.

### BRIEF DESCRIPTION OF THE DRAWINGS

Aspects and embodiments of the disclosure will become more apparent from the detailed description set forth below when taken in conjunction with the drawings in which like reference characters identify correspondingly throughout.

FIG. 1 is a block diagram conceptually illustrating an example of a telecommunications system in accordance with certain aspects of the present disclosure.

FIG. 2 is a block diagram conceptually illustrating an example of a frame structure in a telecommunications system in accordance with certain aspects of the present disclosure.

FIG. 3 is a block diagram conceptually illustrating an example of a Node B in communication with a user equipment device (UE) in a telecommunications system in accordance with certain aspects of the present disclosure.

FIG. 4 is a block diagram conceptually illustrating an example of a frame structure in a telecommunications system in accordance with certain aspects of the present disclosure.

FIG. 5 illustrates an example list of downlink/uplink (DL/UL) configurations in a frame in the TDD-LTE standard in accordance with certain aspects of the present disclosure.

FIG. 6 illustrates an embodiment of baton handover in a TD-SCDMA system in accordance with certain aspects of the present disclosure.

FIG. 7 illustrates an example of frame alignment between a frame in a TDD-LTE network and a frame in TD-SCDMA network in accordance with certain aspects of the present disclosure.

FIG. 8 illustrates example operations for sending a handover command to a user equipment (UE) to perform a baton handover between base stations (BSs) of different radio access technologies (RATs), in accordance with certain aspects of the present disclosure.

FIG. 9 illustrates example operations for receiving a handover command to perform a baton handover between BSs of different RATs, in accordance with certain aspects of the present disclosure.

FIG. 10 illustrates a timing diagram wherein a UE performs a baton handover from a BS of a first RAT to a BS of a second RAT, in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

### An Example Telecommunications System

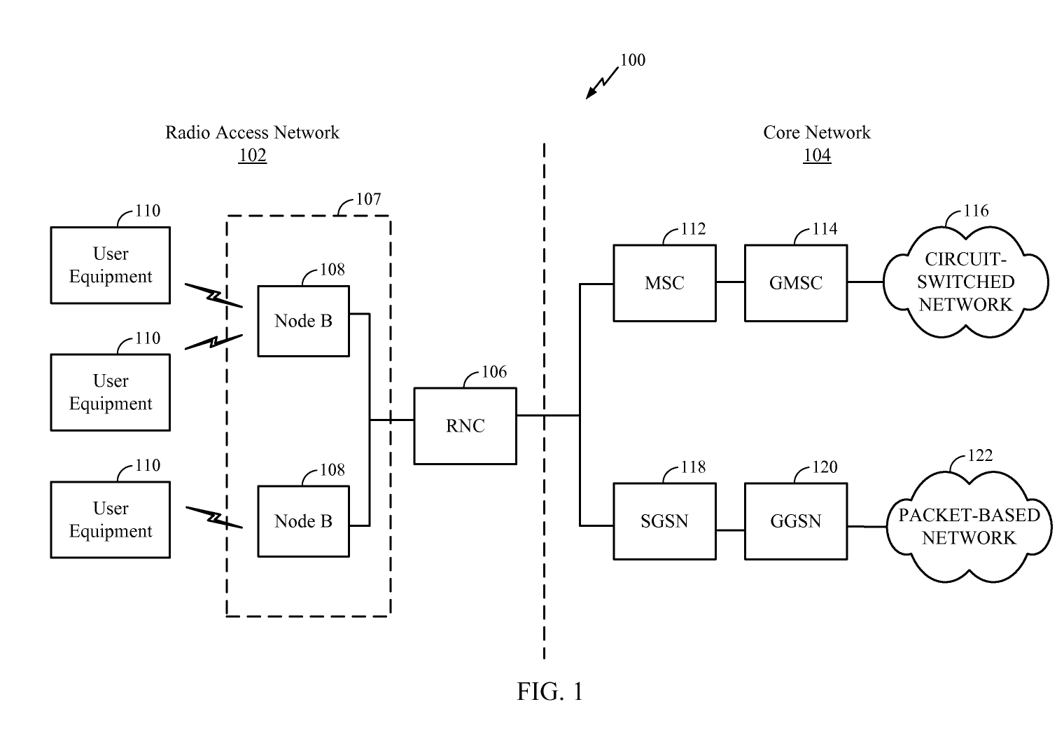

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine a location of the UE and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

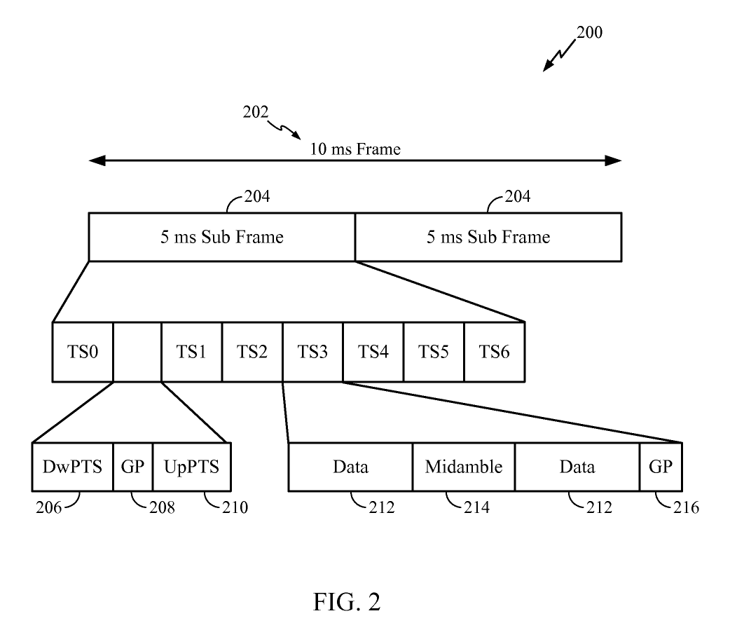

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

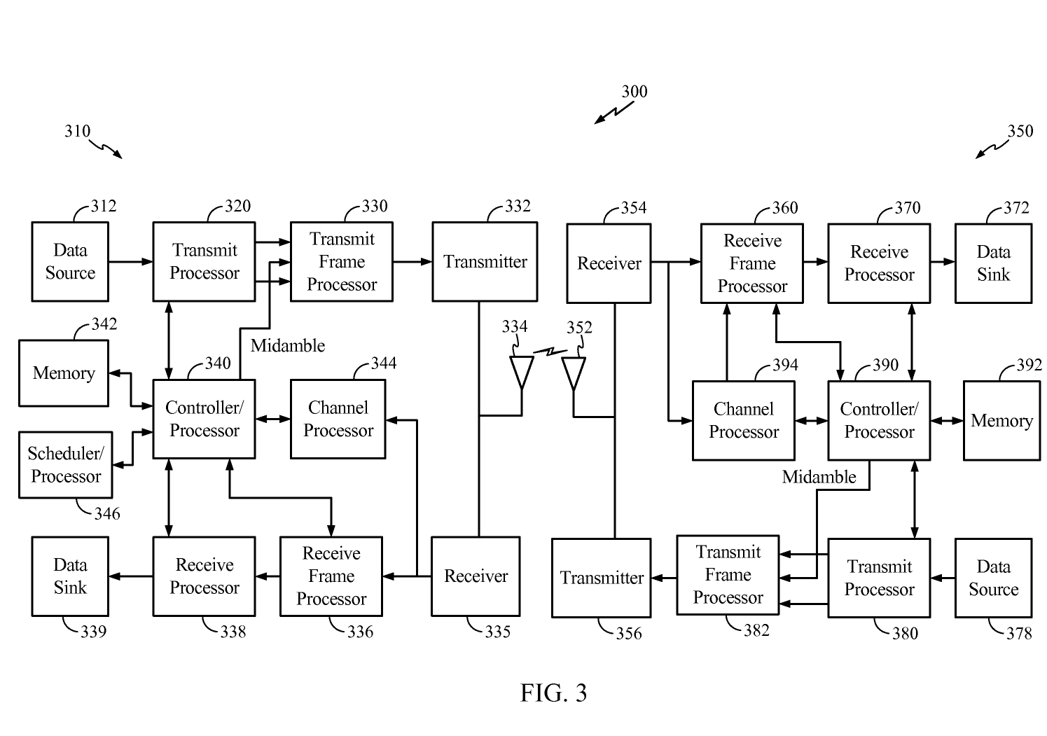

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

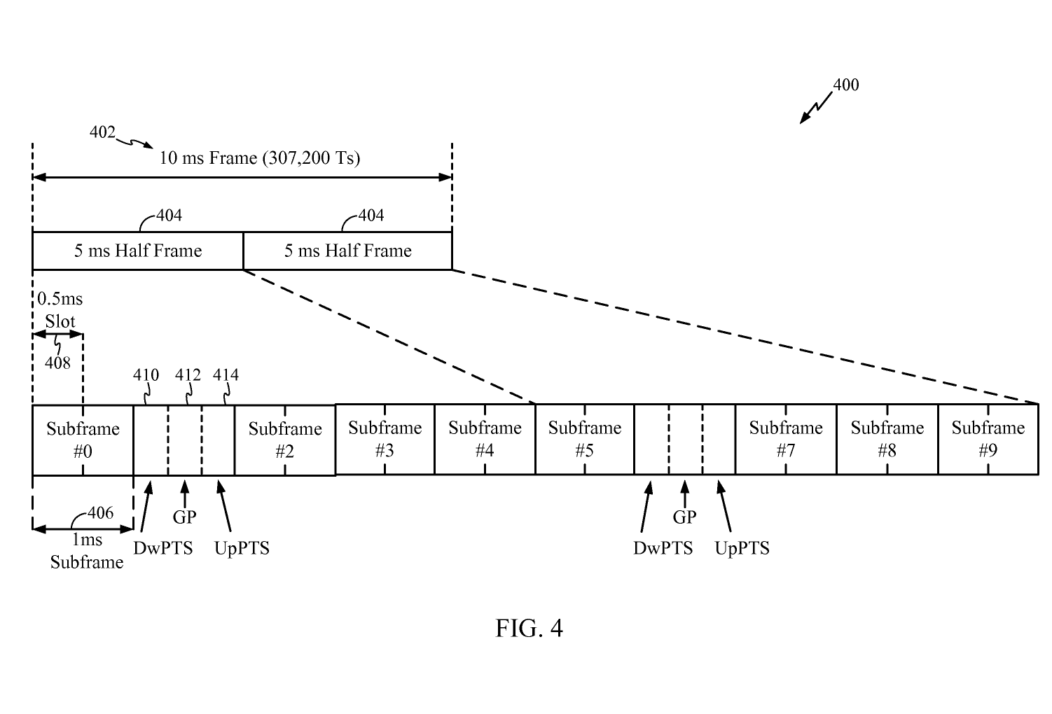

FIG. 4 shows a frame structure 400 for a Time Division Duplex Long Term Evolution (TDD-LTE) carrier. The TDD-LTE carrier, as illustrated, has a frame 402 that is 10 ms in length. The frame 402 has two 5 ms half frames 404, and each of the half frames 404 includes five 1 ms subframes 406. Each subframe 406 may be a downlink subframe (D), an uplink subframe (U), or a special subframe (S). Downlink subframes and uplink subframes may be divided into two 0.5 ms slots 408. Special subframes may be divided into a downlink pilot time slot (DwPTS) 410, a guard period (GP) 412, and an uplink pilot time slot (UpPTS) 414. Depending on the configuration, the duration of DwPTS, UpPTS, and GP may vary.

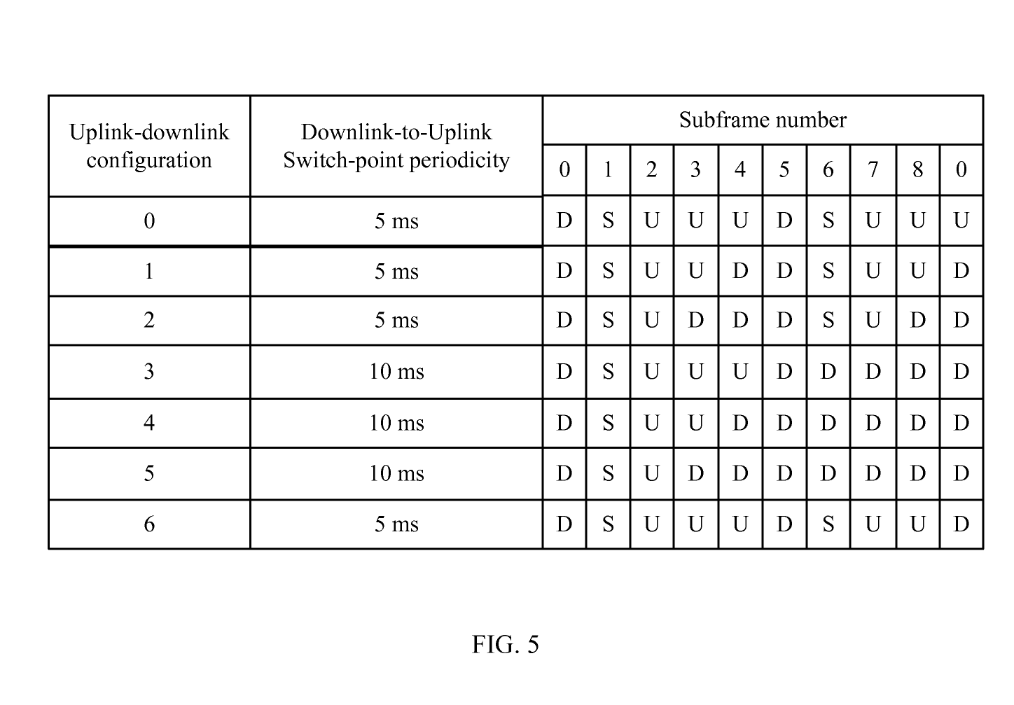

FIG. 5 illustrates an example list of the downlink/uplink configurations in a TDD-LTE frame 402 according to the LTE standard. In this table D, U, and S indicate Downlink, Uplink and Special subframes 406, respectively. The special subframe S may consist of DwPTS 410, GP 412, and UpPTS 414 fields. As illustrated, several DL/UL configurations for 5 ms switch point periodicity and 10 ms switch point periodicity may be chosen for a TDD-LTE frame 402. The configurations 0, 1, and 2 have two identical 5 ms half-frames 404 within a 10 ms TDD-LTE frame 402.

### An Example Method to Perform a Baton Handover from TDD-LTE to TD-SCDMA Systems

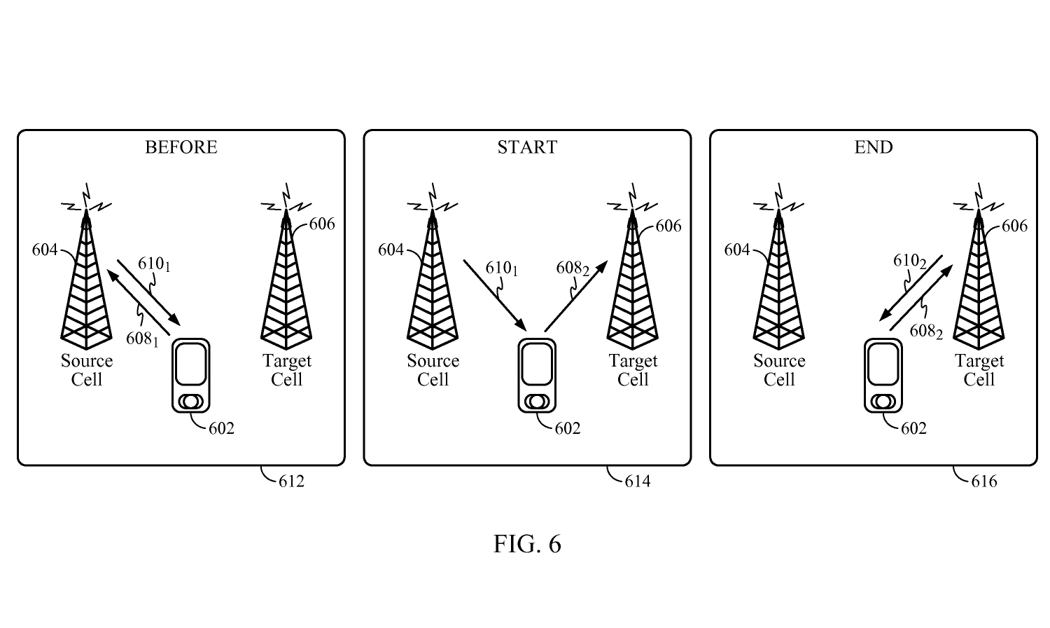

TDD-LTE may be deployed in a way such that the frame transmission is synchronous for the eNB, and the frame boundary is in sync with a TD-SCDMA system. A feature utilized in a TD-SCDMA system is baton handover. FIG. 6 illustrates an embodiment of baton handover in a TD-SCDMA system. Baton handover may comprise a before stage 612, a start stage 614, and an end stage 616. In the before stage 612, a UE 602 may have downlink (DL) transmission 610₁ and uplink (UL) transmission 608₁ with a source cell 604. After receiving a handover command, for example, from the source cell 604, the UE 602 may first switch UL transmission 608₂ to a target cell 606 and then switch DL transmission 610₂ to the target cell 606 after the UL can operate properly. In other words, the UE 602 may maintain the DL transmission 610₁ with the source cell 604 after switching the UL transmission 608₂ with the target cell 606 (i.e., start stage 614). After the UL can operate properly, the UE 602 may switch the DL transmission 610₂ to the target cell 606 (i.e., end stage 616). The two steps in baton handover may allow the target cell 606 to acquire the UL transmission 608₂, measure timing and power, and configure beam forming before the UE 602 switches the DL transmission 610₂. The baton handover may be less disruptive than a hard handover procedure.

For some embodiments of the present disclosure, handover of a UE from a base station (BS) of a first radio access technology (RAT) (e.g., TDD-LTE) to a BS of a second RAT (e.g., Time Division Synchronous Code Division Multiple Access (TD-SCDMA)) may be performed using baton handover. That is, during the baton handover, the UE may switch the UL transmission to the TD-SCDMA network and maintain the DL transmission with the TDD-LTE network until a condition is met.

However, the UE may need to initiate the UL transmission in the TD-SCDMA network with the right timing because there may be no random access procedure performed. Further, the UE may need to establish the UL transmission in the TD-SCDMA network with a proper transmit power. Moreover, the UE may need to maintain the DL transmission in the TDD-LTE network with no UL report in the TDD-LTE network (e.g., channel quality indicator (CQI), pre-coding matrix indication (PMI), rank indicator (RI), and hybrid automatic repeat request acknowledgment (HARQ ACK)). In addition, the network may need to transmit DL to the TDD-LTE network and receive UL from the TD-SCDMA network, as will be described further herein.

For some embodiments, to establish the proper UL transmission timing, open loop timing may be used. For example, the BS of the first RAT may measure the UL transmission from the UE and send a timing advancement command to the UE to precisely adjust the UL timing. The timing advance command may be sent using a Timing Advance Command MAC control element prior to sending the handover command. The UE may immediately apply the TDD-LTE UL transmission timing. Alternatively, the BS of the first RAT may send a command to the UE to initiate random access procedure to perform the timing adjustment, using a physical downlink control channel (PDCCH) order.

After receiving the timing advancement command, the UE may measure the relative delay D of a TD-SCDMA DL frame boundary to the TDD-LTE when first switching the UL transmission (D>0 if TD-SCDMA DL frame is later than the TDD-LTE). The initial UL transmission timing may be:

Initial TD-SCDMA UL TX timing=Current TDD-LTE UL TX timing−D.

For some embodiments, to allow measurement of DL timing in TD-SCDMA, the UE may need to initially tune the DL transmission to the TD-SCDMA network, to measure the timing of a primary common control physical channel (P-CCPCH) at TS0 and return the DL transmission to the TDD-LTE network shortly thereafter.

For some embodiments, to establish the proper UL transmission power, open loop power control may be used. For example, the UE may need to estimate the DL transmission loss by measuring the received power of the P-CCPCH and comparing with the transmit power of the P-CCPCH, as well as a desired UL signal to interference ratio (SIR) (desired_SIR_{DPCH}) and an UL interference/noise level (I_{DPCH}) to decide the initial UL transmission power:

UL-DPCH_{—}T×P=(P-CCPCH_{—}T×P−P-CCPCH_R×P)+(desired_SIR_{DPCH}+I_{DPCH}).

For some embodiments, to allow measurement of DL power on P-CCPCH, the UE may need to initially tune the DL transmission to the TD-SCDMA network at TS0 and return the DL transmission to the TDD-LTE network shortly thereafter.

For some embodiments, to allow the UE to receive DL transmission during baton handover, the BS of the first RAT may need to schedule only DL grants or use DL semi-persistent scheduling (SPS). UL grants may not be scheduled. The BS of the first RAT may continue to use the old CQI/PMI/RI values available before the start of the baton handover, in order to decide the MCS (modulation coding scheme) and transport format used. For some embodiments, the BS of the first RAT may choose to retransmit a packet for a fixed number of times depending on the previous error performance statistics collected (i.e., using a fixed number of retransmissions).

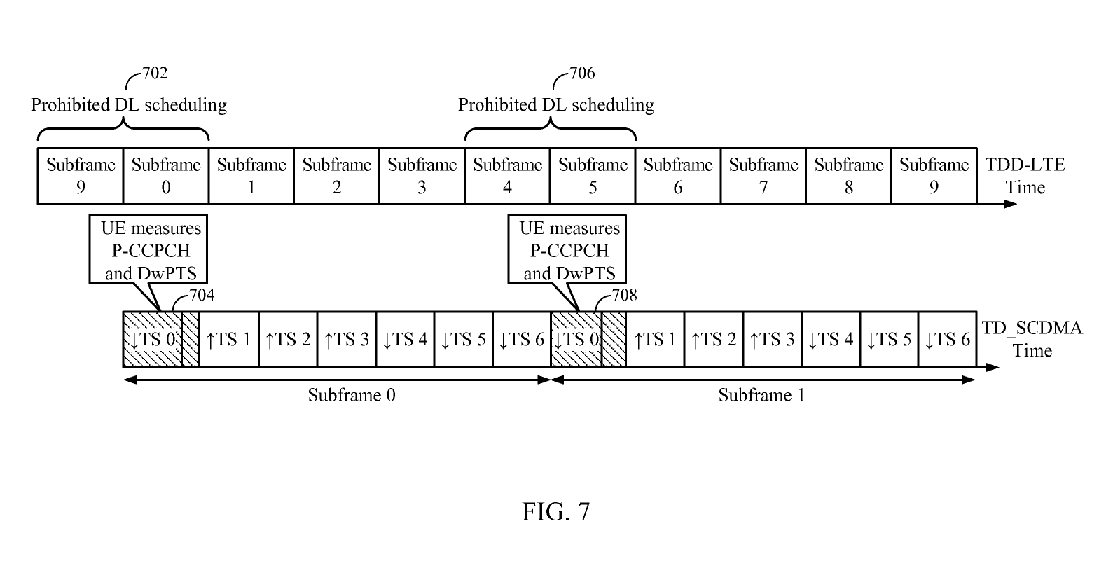

FIG. 7 illustrates an example of frame alignment between a frame in a TDD-LTE network and a frame in TD-SCDMA network in accordance with certain aspects of the present disclosure. For some embodiments, the BS of the first RAT may determine not to schedule DL transmission of the subframe near TS0, which may allow the UE to measure P-CCPCH (and DwPTS) for open loop timing and power control after the baton handover begins. For example, the BS of the TDD-LTE network may determine to prohibit DL scheduling of the subframes 702 near TS0 704 to allow the UE to measure the P-CCPCH at TS0 704. Further, the BS of the TDD-LTE network may determine to prohibit DL scheduling of the subframes 706 near TS0 708 to allow the UE to measure the P-CCPCH at TS0 708.

The Evolved Packet Core (EPC) may receive, from the TD-SCDMA network, the UL path once baton handover starts while maintaining the DL path with the TDD-LTE network until the baton handover ends (e.g., the BS of the TDD-LTE network receives a handover complete message from the UE). For some embodiments, if the EPC must switch DL and UL paths to the TD-SCDMA network simultaneously, the BS of the TDD-LTE network may transmit the remaining DL packets to the UE during the baton handover although the BS of the TDD-LTE network may not be receiving from the EPC any new DL packets.

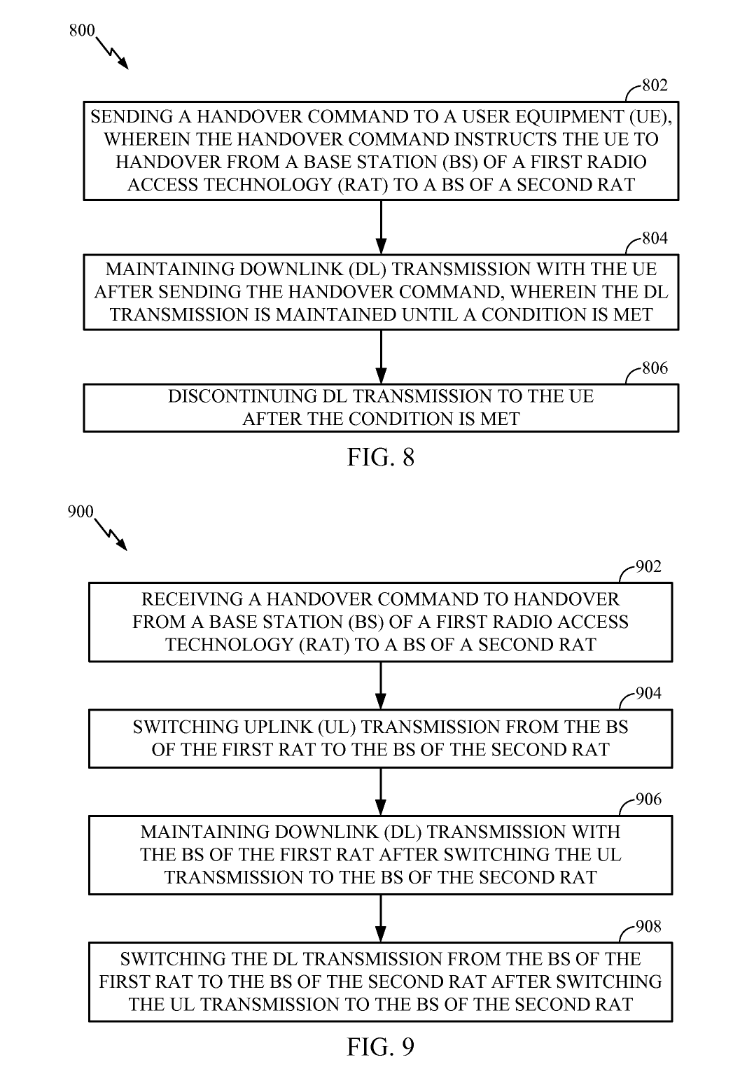

FIG. 8 illustrates example operations 800 in accordance with certain aspects of the present disclosure. The operations 800 may be performed, for example, by a BS of a first RAT in instructing a UE to perform a baton handover. At 802, the BS of the first RAT may send a handover command to the UE, wherein the handover command instructs the UE to handover from the BS of the first RAT to a BS of a second RAT. At 804, the BS of the first RAT may maintain DL transmission with the UE after sending the handover command, wherein the DL transmission is maintained until a condition is met. At 806, the BS of the first RAT may discontinue DL transmission to the UE after the condition is met.

FIG. 9 illustrates example operations 900 in accordance with certain aspects of the present disclosure. The operation 900 may be performed by a UE in performing a baton handover. At 902, the UE may receive a handover command to handover from a BS of a first RAT to a BS of a second RAT. At 904, the UE may switch UL transmission from the BS of the first RAT to the BS of the second RAT. At 906, the UE may maintain DL transmission with the BS of the first RAT after switching the UL transmission to the BS of the second RAT. At 908, the UE may switch the DL transmission from the BS of the first RAT to the BS of the second RAT after switching the UL transmission to the BS of the second RAT.

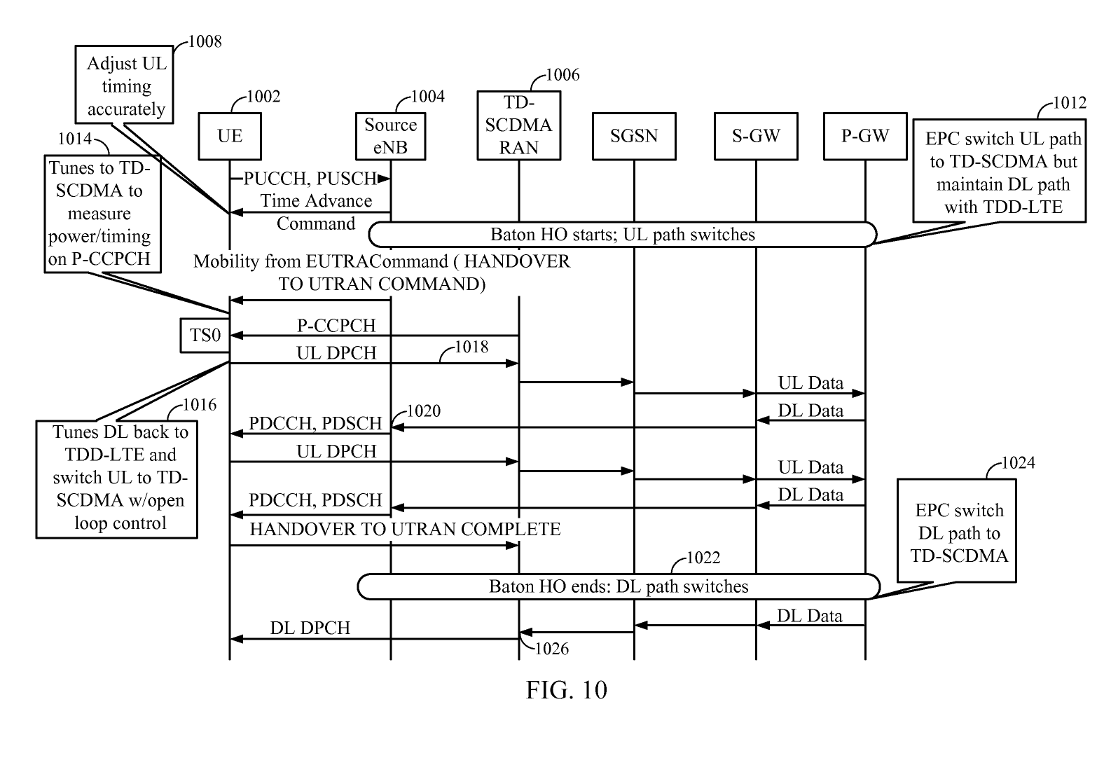

FIG. 10 illustrates a timing diagram wherein a UE 1002 performs a baton handover from a BS of a first RAT 1004 (e.g., TDD-LTE) to a BS of a second RAT 1006 (e.g., TD-SCDMA), in accordance with certain aspects of the present disclosure. At 1008, the BS of the first RAT 1004 may measure the UL transmission from the UE 1002 (e.g., PUCCH, PUSCH) and send a timing advancement command to the UE 1002 to precisely adjust the UL timing.

At 1010, the baton handover may begin, wherein the BS of the first RAT 1004 may send a handover command to the UE 1002 (e.g., HANDOVER TO UTRAN COMMAND). The handover command may not include the fast physical access channel (FPACH) information element (IE); otherwise, the handover command may indicate an inter-RAT non-baton handover. At 1012, the EPC may switch the UL transmission to the BS of the second RAT 1006 but maintain the DL transmission with the BS of the first RAT 1004. At 1014, the UE 1002 may tune the DL transmission to the BS of the second RAT 1006, to measure the power/timing on a P-CCPCH. At 1016, the UE 1002 may return the DL transmission to the BS of the first RAT 1004 and switch the UL transmission to the BS of the second RAT 1006 after measuring the power/timing on the P-CCPCH. As illustrated at 1018, the UL transmission is directed to the BS of the second RAT 1006, while at 1020, the DL transmission is maintained with the BS of the first RAT 1004.

At 1022, the baton handover may end by switching the DL transmission to the BS of the second RAT 1006, wherein the EPC may switch the DL transmission at 1024. For some embodiments, the baton handover may end upon an expiration of a timer. The value of the timer may be provisioned at the UE 1002 or signaled through the handover command. For other embodiments, the baton handover may end upon receipt of confirmation that the UE 1002 has switched the UL transmission from the BS of the first RAT 1004 to the BS of the second RAT 1006. As illustrated at 1026, the DL transmission is switched to the BS of the second RAT 1006.

Several aspects of a telecommunications system have been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read-only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method for wireless communications, comprising:
sending a handover command to a user equipment (UE), wherein the handover command instructs the UE to handover from a base station (BS) of a first radio access technology (RAT) to a BS of a second RAT;
maintaining downlink (DL) transmission with the UE after sending the handover command, wherein the DL transmission is maintained until a condition is met; and
discontinuing DL transmission to the UE after the condition is met.

2. The method of claim 1, wherein the first RAT comprises Time Division Duplex Long Term Evolution (TDD-LTE).

3. The method of claim 1, wherein the second RAT comprises Time Division Synchronous Code Division Multiple Access (TD-SCDMA).

4. The method of claim 1, wherein the condition is met upon an expiration of a timer.

5. The method of claim 1, wherein the condition is met upon receiving a confirmation that the UE has switched uplink (UL) transmission from the BS of the first RAT to the BS of the second RAT.

6. The method of claim 1, wherein the BS of the first RAT sends the handover command.

7. The method of claim 1, wherein maintaining the DL transmission comprises using a channel quality indicator (CQI) received from the UE prior to sending the handover command.

8. The method of claim 1, wherein maintaining the DL transmission comprises using a fixed number of retransmissions.

9. An apparatus for wireless communications, comprising:
means for sending a handover command to a user equipment (UE), wherein the handover command instructs the UE to handover from a base station (BS) of a first radio access technology (RAT) to a BS of a second RAT;
means for maintaining downlink (DL) transmission with the UE after sending the handover command, wherein the DL transmission is maintained until a condition is met; and
means for discontinuing DL transmission to the UE after the condition is met.

10. The apparatus of claim 9, wherein the first RAT comprises Time Division Duplex Long Term Evolution (TDD-LTE).

11. The apparatus of claim 9, wherein the second RAT comprises Time Division Synchronous Code Division Multiple Access (TD-SCDMA).

12. The apparatus of claim 9, wherein the condition is met upon an expiration of a timer.

13. The apparatus of claim 9, wherein the condition is met upon receiving a confirmation that the UE has switched uplink (UL) transmission from the BS of the first RAT to the BS of the second RAT.

14. The apparatus of claim 9, wherein the BS of the first RAT sends the handover command.

15. The apparatus of claim 9, wherein the means for maintaining the DL transmission comprises means for using a channel quality indicator (CQI) received from the UE prior to sending the handover command.

16. The apparatus of claim 9, wherein the means for maintaining the DL transmission comprises means for using a fixed number of retransmissions.

17. An apparatus for wireless communications, comprising:
at least one processor adapted to:
send a handover command to a user equipment (UE), wherein the handover command instructs the UE to handover from a base station (BS) of a first radio access technology (RAT) to a BS of a second RAT;
maintain downlink (DL) transmission with the UE after sending the handover command, wherein the DL transmission is maintained until a condition is met; and
discontinue DL transmission to the UE after the condition is met; and
a memory coupled to the at least one processor.

18. The apparatus of claim 17, wherein the first RAT comprises Time Division Duplex Long Term Evolution (TDD-LTE).

19. The apparatus of claim 17, wherein the second RAT comprises Time Division Synchronous Code Division Multiple Access (TD-SCDMA).

20. The apparatus of claim 17, wherein the condition is met upon an expiration of a timer.

21. The apparatus of claim 17, wherein the condition is met upon receiving a confirmation that the UE has switched uplink (UL) transmission from the BS of the first RAT to the BS of the second RAT.

22. The apparatus of claim 17, wherein the BS of the first RAT sends the handover command.

23. The apparatus of claim 17, wherein the at least one processor adapted to maintain the DL transmission comprises using a channel quality indicator (CQI) received from the UE prior to sending the handover command.

24. The apparatus of claim 17, wherein the at least one processor adapted to maintain the DL transmission comprises using a fixed number of retransmissions.

25. A computer-program product, comprising:
a computer-readable medium comprising code for:
sending a handover command to a user equipment (UE), wherein the handover command instructs the UE to handover from a base station (BS) of a first radio access technology (RAT) to a BS of a second RAT;
maintaining downlink (DL) transmission with the UE after sending the handover command, wherein the DL transmission is maintained until a condition is met; and
discontinuing DL transmission to the UE after the condition is met.

26. The computer-program product of claim 25, wherein the first RAT comprises Time Division Duplex Long Term Evolution (TDD-LTE).

27. The computer-program product of claim 25, wherein the second RAT comprises Time Division Synchronous Code Division Multiple Access (TD-SCDMA).

28. The computer-program product of claim 25, wherein the condition is met upon an expiration of a timer.

29. The computer-program product of claim 25, wherein the condition is met upon receiving a confirmation that the UE has switched uplink (UL) transmission from the BS of the first RAT to the BS of the second RAT.

30. The computer-program product of claim 25, wherein the BS of the first RAT sends the handover command.

31. The computer-program product of claim 25, wherein the code for maintaining the DL transmission comprises code for using a channel quality indicator (CQI) received from the UE prior to sending the handover command.

32. The computer-program product of claim 25, wherein the code for maintaining the DL transmission comprises code for using a fixed number of retransmissions.

33. A method for wireless communications, comprising:
receiving a handover command to handover from a base station (BS) of a first radio access technology (RAT) to a BS of a second RAT;
switching uplink (UL) transmission from the BS of the first RAT to the BS of the second RAT;
maintaining downlink (DL) transmission with the BS of the first RAT after switching the UL transmission to the BS of the second RAT; and
switching the DL transmission from the BS of the first RAT to the BS of the second RAT after switching the UL transmission to the BS of the second RAT.

34. The method of claim 33, wherein the first RAT comprises Time Division Duplex Long Term Evolution (TDD-LTE).

35. The method of claim 33, wherein the second RAT comprises Time Division Synchronous Code Division Multiple Access (TD-SCDMA).

36. The method of claim 33, wherein switching the UL transmission comprises adjusting timing for the UL transmission.

37. The method of claim 36, wherein the timing for the UL transmission is adjusted based on a DL measurement of a DL frame boundary of the second RAT.

38. The method of claim 36, wherein adjusting the timing comprises:
receiving a timing advance command from the BS of the first RAT;
measuring a delay of a DL frame boundary of the second RAT to the first RAT; and
applying the timing advance command and the delay to the timing for the UL transmission.

39. The method of claim 38, wherein measuring the delay is performed before receiving the handover command.

40. The method of claim 33, wherein switching the UL transmission comprises adjusting a transmit power for the UL transmission.

41. The method of claim 40, wherein the transmit power for the UL transmission is adjusted based on a DL measurement of a DL frame boundary of the second RAT.

42. The method of claim 41, wherein the DL measurement is a measurement of received power.

43. The method of claim 41, wherein the DL measurement is received before receiving the handover command.

44. The method of claim 33, wherein the handover command is received from the BS of the first RAT.

45. An apparatus for wireless communications, comprising:
means for receiving a handover command to handover from a base station (BS) of a first radio access technology (RAT) to a BS of a second RAT;
means for switching uplink (UL) transmission from the BS of the first RAT to the BS of the second RAT;
means for maintaining downlink (DL) transmission with the BS of the first RAT after switching the UL transmission to the BS of the second RAT; and
means for switching the DL transmission from the BS of the first RAT to the BS of the second RAT after switching the UL transmission to the BS of the second RAT.

46. The apparatus of claim 45, wherein the first RAT comprises Time Division Duplex Long Term Evolution (TDD-LTE).

47. The apparatus of claim 45, wherein the second RAT comprises Time Division Synchronous Code Division Multiple Access (TD-SCDMA).

48. The apparatus of claim 45, wherein the means for switching the UL transmission comprises means for adjusting timing for the UL transmission.

49. The apparatus of claim 48, wherein the timing for the UL transmission is adjusted based on a DL measurement of a DL frame boundary of the second RAT.

50. The apparatus of claim 48, wherein the means for adjusting the timing comprises:
means for receiving a timing advance command from the BS of the first RAT;
means for measuring a delay of a DL frame boundary of the second RAT to the first RAT; and
means for applying the timing advance command and the delay to the timing for the UL transmission.

51. The apparatus of claim 50, wherein measuring the delay is performed before receiving the handover command.

52. The apparatus of claim 45, wherein the means for switching the UL transmission comprises means for adjusting a transmit power for the UL transmission.

53. The apparatus of claim 52, wherein the transmit power for the UL transmission is adjusted based on a DL measurement of a DL frame boundary of the second RAT.

54. The apparatus of claim 53, wherein the DL measurement is a measurement of received power.

55. The apparatus of claim 53, wherein the DL measurement is received before receiving the handover command.

56. The apparatus of claim 45, wherein the handover command is received from the BS of the first RAT.

57. An apparatus for wireless communications, comprising:
at least one processor adapted to:
receive a handover command to handover from a base station (BS) of a first radio access technology (RAT) to a BS of a second RAT;
switch uplink (UL) transmission from the BS of the first RAT to the BS of the second RAT;
maintain downlink (DL) transmission with the BS of the first RAT after switching the UL transmission to the BS of the second RAT; and
switch the DL transmission from the BS of the first RAT to the BS of the second RAT after switching the UL transmission to the BS of the second RAT; and
a memory coupled to the at least one processor.

58. The apparatus of claim 57, wherein the first RAT comprises Time Division Duplex Long Term Evolution (TDD-LTE).

59. The apparatus of claim 57, wherein the second RAT comprises Time Division Synchronous Code Division Multiple Access (TD-SCDMA).

60. The apparatus of claim 57, wherein the at least one processor adapted to switch the UL transmission comprises adjusting timing for the UL transmission.

61. The apparatus of claim 60, wherein the timing for the UL transmission is adjusted based on a DL measurement of a DL frame boundary of the second RAT.

62. The apparatus of claim 60, wherein the at least one processor adapted to adjust the timing comprises:
receiving a timing advance command from the BS of the first RAT;
measuring a delay of a DL frame boundary of the second RAT to the first RAT; and
applying the timing advance command and the delay to the timing for the UL transmission.

63. The apparatus of claim 62, wherein measuring the delay is performed before receiving the handover command.

64. The apparatus of claim 57, wherein the at least one processor adapted to switch the UL transmission comprises adjusting a transmit power for the UL transmission.

65. The apparatus of claim 64, wherein the transmit power for the UL transmission is adjusted based on a DL measurement of a DL frame boundary of the second RAT.

66. The apparatus of claim 65, wherein the DL measurement is a measurement of received power.

67. The apparatus of claim 65, wherein the DL measurement is received before receiving the handover command.

68. The apparatus of claim 57, wherein the handover command is received from the BS of the first RAT.

69. A computer-program product, comprising:
a computer-readable medium comprising code for:
receiving a handover command to handover from a base station (BS) of a first radio access technology (RAT) to a BS of a second RAT;
switching uplink (UL) transmission from the BS of the first RAT to the BS of the second RAT;
maintaining downlink (DL) transmission with the BS of the first RAT after switching the UL transmission to the BS of the second RAT; and
switching the DL transmission from the BS of the first RAT to the BS of the second RAT after switching the UL transmission to the BS of the second RAT.

70. The computer-program product of claim 69, wherein the first RAT comprises Time Division Duplex Long Term Evolution (TDD-LTE).

71. The computer-program product of claim 69, wherein the second RAT comprises Time Division Synchronous Code Division Multiple Access (TD-SCDMA).

72. The computer-program product of claim 69, wherein the code for switching the UL transmission comprises code for adjusting timing for the UL transmission.

73. The computer-program product of claim 72, wherein the timing for the UL transmission is adjusted based on a DL measurement of a DL frame boundary of the second RAT.

74. The computer-program product of claim 72, wherein the code for adjusting the timing comprises code for:
receiving a timing advance command from the BS of the first RAT;
measuring a delay of a DL frame boundary of the second RAT to the first RAT; and
applying the timing advance command and the delay to the timing for the UL transmission.

75. The computer-program product of claim 74, wherein measuring the delay is performed before receiving the handover command.

76. The computer-program product of claim 69, wherein the code for switching the UL transmission comprises code for adjusting a transmit power for the UL transmission.

77. The computer-program product of claim 76, wherein the transmit power for the UL transmission is adjusted based on a DL measurement of a DL frame boundary of the second RAT.

78. The computer-program product of claim 77, wherein the DL measurement is a measurement of received power.

79. The computer-program product of claim 77, wherein the DL measurement is received before receiving the handover command.

80. The computer-program product of claim 69, wherein the handover command is received from the BS of the first RAT.
